(19) United States
(12) Patent Application Publication
(10) Pub. No.: US 2012/0172015 A1
(43) Pub. Date: Jul. 5, 2012

(54) METHOD OF OVER-THE AIR PERSONALIZATION AND COMMUNICATION DEVICE IMPLEMENTING THE SAME

(75) Inventor: Yu-Wei Fan, New Taipei City (TW)

(73) Assignee: WISTRON CORPORATION, New Taipei City (TW)

(21) Appl. No.: 13/243,919

(22) Filed: Sep. 23, 2011

(30) Foreign Application Priority Data
Jan. 5, 2011 (TW) 100100308

(51) Int. Cl. H04W 4/00

(52) U.S. Cl. 455/414.1

(57) ABSTRACT

A method of over-the-air (OTA) personalization of a communication device is provided. In this method, the communication device is configured to receive an OTA message, to determine if the OTA message includes personalization data to be used for personalizing the communication device, and to implement a personalization procedure according to the personalization data when it is determined that the OTA message includes the personalization data.

### CROSS-REFERENCE TO RELATED APPLICATION

This application claims priority of Taiwanese Patent Application No. 100100308, filed on Jan. 5, 2011, the disclosure of which is incorporated herein by reference.

### BACKGROUND OF THE INVENTION

1. Field of the Invention

The present invention relates to a method of personalization, more particularly to a method of over-the-air personalization.

2. Description of the Related Art

A telecommunication operator usually requires a subscriber to make a contract therewith when a communication device is sold to the subscriber, and provides a SIM (Subscriber Identity Module) card, the contract contents, etc. to the subscriber. The telecommunication operator also requires cell phone manufacturers to personalize communication devices to be sold by the telecommunication operator, for example, limiting the communication devices to the SIM cards provided by the telecommunication operator. As a result, the communication device can only be used with a SIM card provided by the telecommunication operator.

Currently, for personalization of a communication device, after the communication device is manufactured by a factory and has all relevant functions verified, personalization data (such as a personalization indicator, a personalization control code, etc.) is written into the communication device through a work station executing software for completing the personalization procedure. However, an additional work station or particular software is required for such personalization procedure. Thus, it takes a relatively longer time for implementing the personalization procedure, and production efficiency is thus reduced.

### SUMMARY OF THE INVENTION

Therefore, an object of the present invention is to provide a method of over-the-air personalization of a communication device capable of reducing time for implementing a personalization procedure to increase production efficiency.

Accordingly, a method of over-the-air (OTA) personalization of a communication device is provided. The method comprises the following steps of:

a) configuring the communication device to receive an OTA message;

b) configuring the communication device to determine if the OTA message includes personalization data to be used for personalizing the communication device; and

c) when it is determined in step b) that the OTA message includes the personalization data, configuring the communication device to implement a personalization procedure according to the personalization data.

Preferably, the OTA message received in step a) includes an information element for personalization, and a protocol discriminator corresponding to the information element. The information element includes the personalization data. In step b), the communication device is configured to decode the protocol discriminator to thereby determine if the information element includes the personalization data.

Alternatively, the OTA message received in step a) includes an information element about mobility management that has a sub-message for personalization and a message type corresponding to the sub-message. The sub-message includes the personalization data. In step b), the communication device is configured to decode the message type to thereby determine if the sub-message includes the personalization data.

Alternatively, the OTA message received in step a) includes an information element about short message service that has a personalization message. The personalization message includes the personalization data. In step b), the communication device is configured to determine if the information element about short message service includes the personalization data.

Preferably, step c) includes the following sub-steps of:

c1) configuring the communication device to decode the OTA message to obtain the personalization data;

c2) configuring the communication device to determine if the personalization data is correct; and

c3) when it is determined in sub-step c2) that the personalization data is correct, configuring the communication device to implement the personalization procedure according to the personalization data.

According to another aspect, a computer program product comprises a machine readable storage medium having program instructions stored therein which when executed cause a processing unit to perform the method of over-the-air personalization of a communication device.

Another object of the present invention is to provide a communication device capable of communication with a personalization server through a wireless network to obtain an over-the-air (OTA) message for implementing a personalization procedure.

Accordingly, a communication device of this invention comprises a transceiving unit for receiving the OTA message from the personalization server, and a processing unit coupled to the transceiving unit. The processing unit is operable to determine if the OTA message includes personalization data to be used for personalizing the communication device, and to implement a personalization procedure according to the personalization data when it is determined that the OTA message includes the personalization data.

### BRIEF DESCRIPTION OF THE DRAWINGS

Other features and advantages of the present invention will become apparent in the following detailed description of the embodiments with reference to the accompanying drawings, of which:

FIG. 1 is a flowchart of a first embodiment of a method of over-the-air (OTA) personalization of a communication device according to the present invention;

FIG. 2 is a schematic system block diagram illustrating a communication device communicating with a personalization server through a wireless network;

FIG. 3 illustrates an OTA message in the first preferred embodiment;

FIG. 4 is a flowchart illustrating a personalization procedure in detail;

FIG. 5 is a flowchart of a second embodiment of a method of OTA personalization of a communication device according to the present invention;

FIG. 6 illustrates an OTA message in the second embodiment;

FIG. 7 is a schematic system block diagram illustrating a communication device used in the second embodiment;

FIG. 8 is a flowchart of a third embodiment of a method of OTA personalization of a communication device according to the present invention;

FIG. 9 illustrates an OTA message in the third embodiment; and

FIG. 10 is a schematic system block diagram illustrating a communication device used in the third embodiment.

### DETAILED DESCRIPTION OF THE PREFERRED EMBODIMENTS

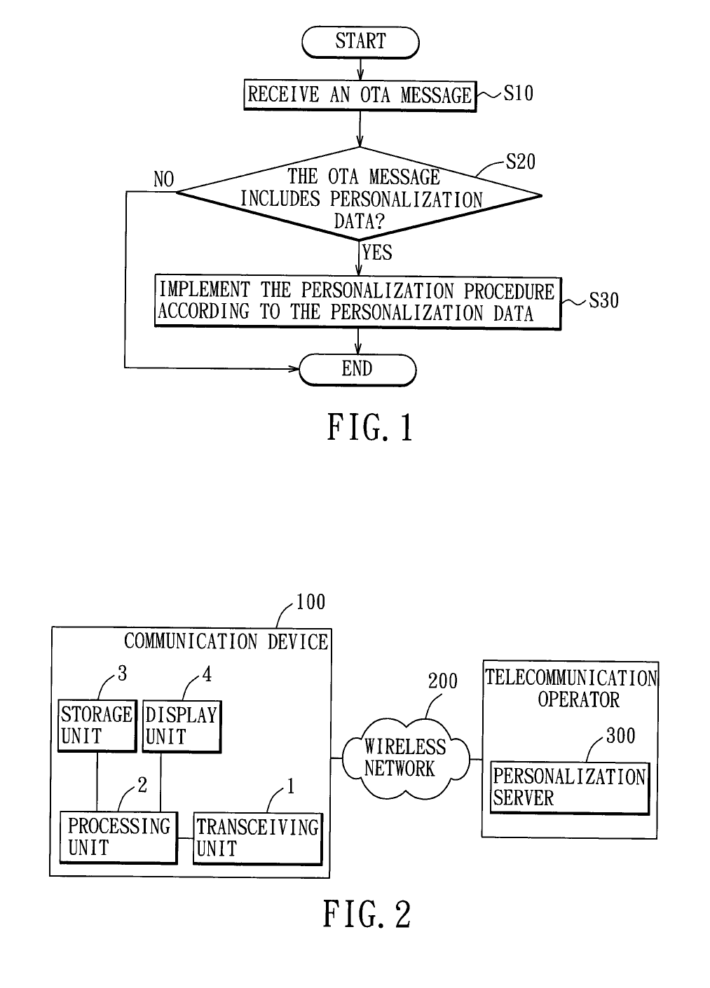

Referring to FIGS. 1 and 2, a first embodiment of a method of over-the-air (OTA) personalization of a communication device is to be implemented in a communication device 100. The communication device 100 is capable of communication with a personalization server 300 installed at a telecommunication operator (such as a retailer or a service center) through a wireless network 200 (which may be a second or third generation mobile telecommunication) for completing personalization of the communication device 100.

In this embodiment, the communication device 100 includes a transceiving unit 1, a processing unit 2, a storage unit 3, and a display unit 4. The transceiving unit 1 is configured for communication with the personalization server 300 to transmit/receive messages, data and information therebetween. The storage unit 3 stores specification and a model number of the communication device 100. The display unit 4 is configured for displaying content of a message received by the transceiving unit 1. The processing unit 2 is coupled to the transceiving unit 1, the display unit 4 and the storage unit 3 for controlling operations thereof, for example, processing messages or information received by the transceiving unit 1.

A detailed description of a personalization procedure of the method for personalizing the communication device 100 through the wireless network 200 and the personalization server 300 is provided in the following.

In the following description, it is assumed that the communication device 100 has been purchased by a subscriber from a telecommunication operator, and a Subscriber Identity Module (SIM) card with specified International Mobile Subscriber Identity (IMSI) is provided to the subscriber. IMSI is a 15-digit number composed of Mobile Country Code (MCC), Mobile Network Code (MNC) and Mobile Station Identification Number (MSIN).

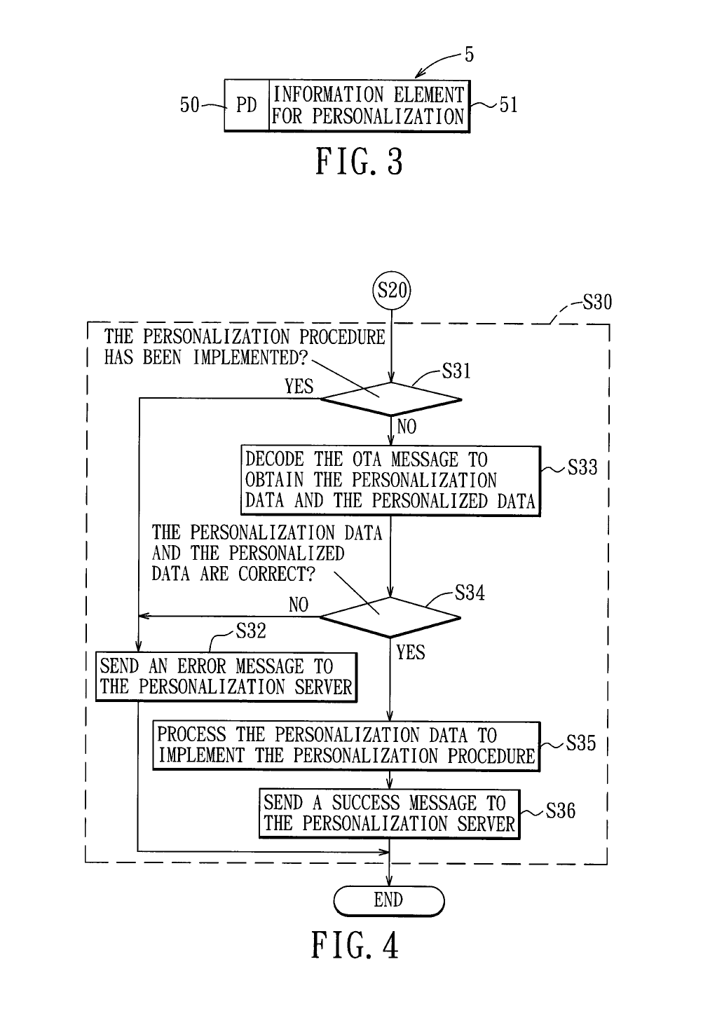

In step S10, the transceiving unit 1 is operable to receive an OTA message 5 from the personalization server 300 through the wireless network 200. With reference to FIG. 3, the OTA message 5 is a type of a layer 3 (L3) message, and includes an information element 51 for personalization, and a protocol discriminator (PD) 50 corresponding to the information element 51. The information element 51 includes personalization data. It should be noted that a number and types of information elements in the OTA message 5 are not limited to the disclosure of this embodiment. In other embodiments, the OTA message 5 may include other information fields about, for example, Short Message Service (SMS), Mobility Management (MM), Call Control (CC), etc.

In step S20, the processing unit 2 is operable to determine whether the OTA message 5 includes personalization data. In this embodiment, the processing unit 2 is configured to decode the protocol discriminator 50 to thereby determine if the information element 51 includes the personalization data. If it is determined that the information element 51 includes the personalization data, the flow goes to step S30. If it is determined that the information element 51 does not include the personalization data, that is to say, the OTA message 5 does not include personalization data, the processing unit 2 is operable to terminate the personalization procedure without further steps.

In step S30, the processing unit 2 is operable to implement the personalization procedure according to the personalization data for personalizing the communication device 100.

Referring to FIG. 4, step S30 includes sub-steps S31 to S36 described in detail in the following.

In sub-step S31, the processing unit 2 is operable to determine whether the personalization procedure has been implemented in the communication device 100, i.e., whether the storage unit 3 has stored parameters related to implementation of the personalization procedure. If the determination made in sub-step S31 is affirmative, the processing unit 2 will not repeat the personalization procedure for the communication device 100, and will implement sub-step S32 to generate and send an error message to the personalization server 300 through the transceiving unit 1 to notify the telecommunication operator. If the determination made in sub-step S31 is negative, the flow goes to sub-step S33.

In sub-step S33, the processing unit 2 is operable to decode the OTA message 5 (i.e., the information element 51 for personalization) to thereby obtain the personalization data and personalized data. In this embodiment, the personalized data includes International Mobile Equipment Identity (IMEI), a control code for unlocking the personalization, and parameters required for the personalization procedure.

In sub-step S34, the processing unit 2 is operable to determine whether the personalization data and the personalized data are correct. In this embodiment, the processing unit 2 is configured to determine whether specification of the personalization data (such as a number of bits) conforms with a predetermined standard, whether the IMEI and the control code decoded from the personalization data in sub-step S33 are respectively identical to IMEI and a control code stored in the storage unit 3, and whether the parameters required for the personalization procedure are correct. If all the aforementioned determinations are affirmative, it is determined that the personalization data and the personalized data are correct, and the processing unit 2 is operable to implement sub-step S35. If any one of the aforementioned determinations is negative, it is determined that the personalization data and the personalized data are incorrect, and the processing unit 2 will implement sub-step S32 to generate and send an error message to the personalization server 300 through the transceiving unit 1.

It should be noted that the OTA message 5 may not necessarily include the personalized data in other embodiments. In such case, only the personalization data is decoded from the OTA message 5 in sub-step S33, and it is only needed to determine whether the personalization data is correct in sub-step S34. Moreover, the content of the personalized data is not limited to the disclosure of this embodiment, and may be varied according to specifications and requirements of the telecommunication operator.

In sub-step S35, the processing unit 2 is operable to process the personalization data so as to implement the personalization procedure. Thus, the communication device 100 is configured to be used only with a SIM card provided by the telecommunication operator.

In sub-step S36, the processing unit 2 is operable to generate and send a success message to the personalization server 300 through the transceiving unit 1 to notify the telecommunication operator that the personalization procedure is successfully completed.

Therefore, according to this invention, the communication device 100 in this embodiment is able to communicate with the personalization server 300 via the wireless network 200 so that the personalization server 300 is able to perform the personalization procedure of the communication device 100 only by transmitting the OTA message 5 to the communication device 100 by means of, for example, sending a short message. In such a manner, the personalization procedure of the communication device 100 can be completed without an additional work station or execution of particular software so that time for implementing the personalization procedure is reduced and production efficiency is increased. Moreover, the method of OTA personalization according to this invention also prevents a malicious user from illegally unlocking, cracking or changing the personalization of the communication device 100.

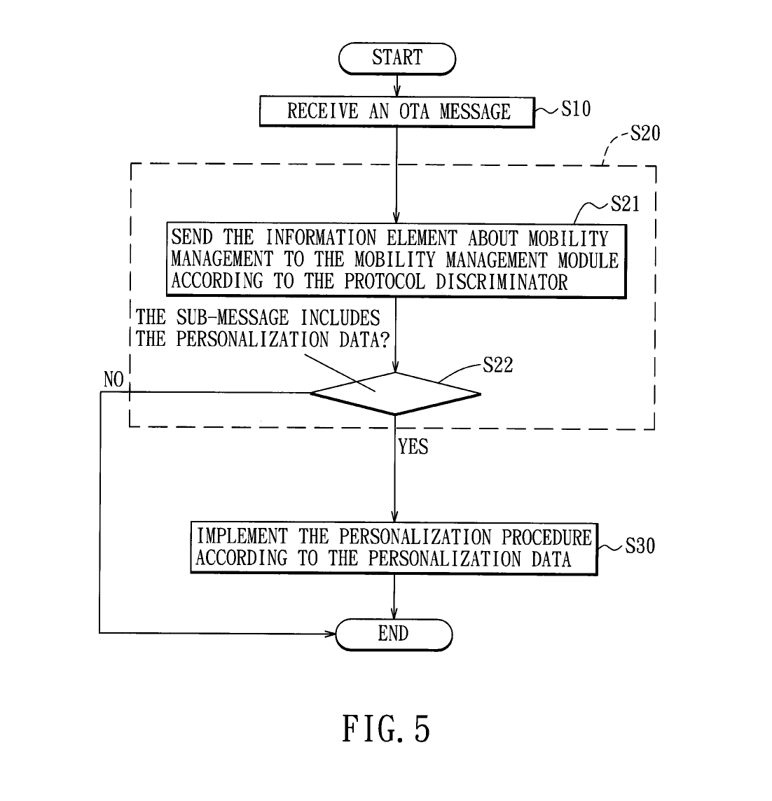

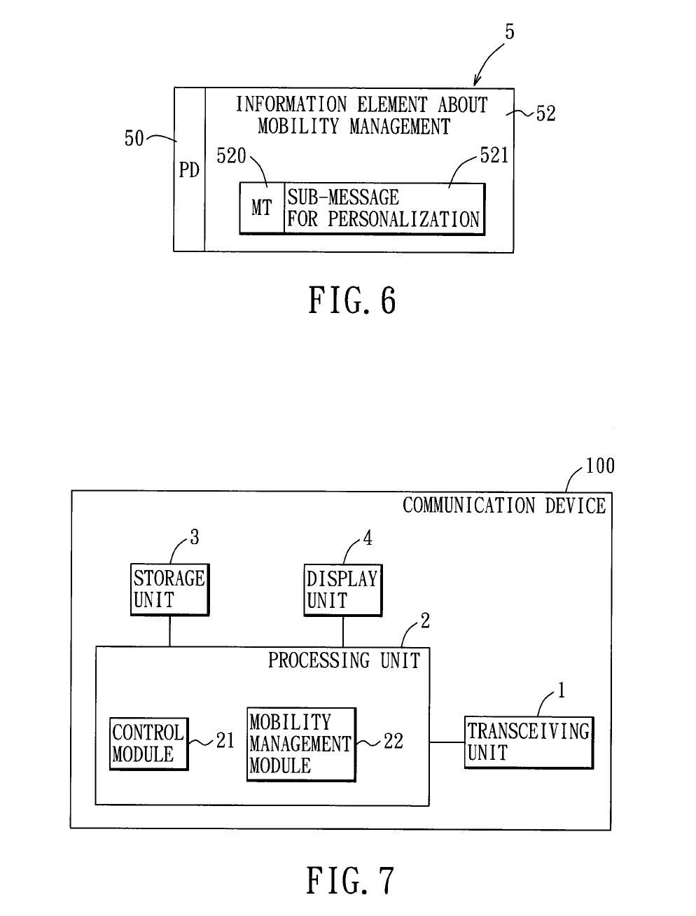

Referring to FIGS. 5 to 7, a second embodiment of a method of OTA personalization of a communication device according to the present invention is shown to be similar to the first embodiment. In this embodiment, the OTA message 5 includes an information element 52 about mobility management and a protocol discriminator (PD) 50 corresponding to the information element 52. The information element 52 about mobility management has a sub-message 521 for personalization and a message type (MT) 520 corresponding to the sub-message 521. In this embodiment, the sub-message 521 for personalization includes personalization data for personalizing a communication device 100.

As shown in FIG. 7, in this embodiment, the processing unit 2 includes a control module 21 and a mobility management module 22. The control module 21 is configured to implement the personalization procedure. The mobility management module 22 is configured to process related content of the information element 52 about mobility management.

As shown in FIG. 5, the transceiving unit 1 is operable to receive the OTA message 5 from the personalization server 300 through the wireless network 200 in step S10 (similar to step S10 of the first embodiment). Then, in step S20, the processing unit 2 is operable to determine if the OTA message 5 includes the personalization data to be used for personalizing the communication device 100. In this embodiment, step S20 includes the following sub-steps.

In sub-step S21, according to the protocol discriminator 50 of the OTA message 5, the processing unit 2 is operable to send the information element 52 about mobility management to the mobility management module 22 for processing the information element 52.

In sub-step S22, the mobility management module 22 is operable to decode the message type 520 to thereby determine if the sub-message 521 includes the personalization data. If the sub-message 521 includes the personalization data, the control module 21 is operable to implement the personalization procedure according to the personalization data for personalizing the communication device 100 in step S30 (similar to step S30 of the first embodiment). Otherwise, the processing unit 2 is operable to terminate the personalization procedure without further steps. It should be noted that, in sub-step S33 of this embodiment (see FIG. 4), the control module 21 is operable to decode the sub-message 521 to thereby obtain the personalization data.

Therefore, the communication device 100 in this embodiment is also able to communicate with the personalization server 300 via the wireless network 200 so that the personalization server 300 is able to perform the personalization procedure of the communication device 100 without an additional work station or execution of particular software. As a result, the time for implementing the personalization procedure is reduced, and production efficiency is increased.

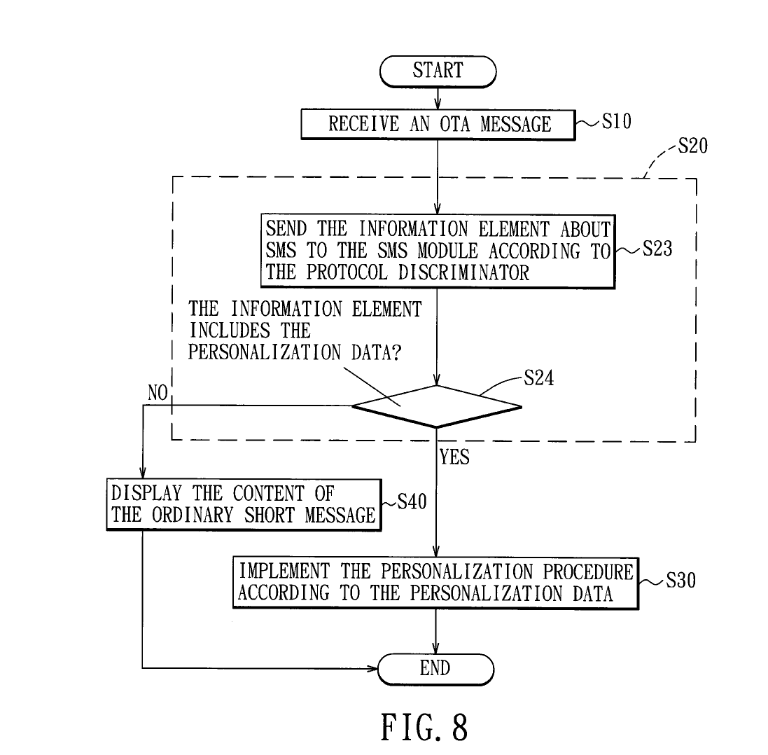

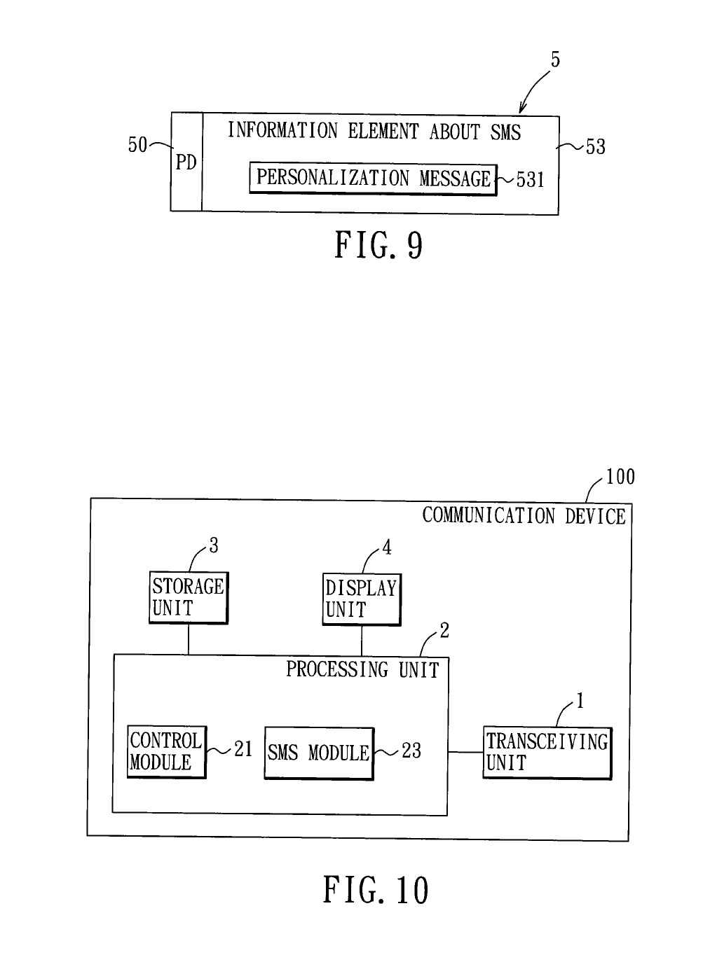

Referring to FIGS. 8 to 10, a third embodiment of a method of OTA personalization of a communication device according to the present invention is shown to be similar to the second embodiment. In this embodiment, the OTA message 5 received in step S10 is a type of a short message, and includes an information element 53 about short message service and a protocol discriminator (PD) 50 corresponding to the information element 53. The information element 53 about short message service has a personalization message 531. In this embodiment, the personalization message 531 includes personalization data for personalizing a communication device 100. Namely, the personalization server 300 of this embodiment is configured to implement the personalization procedure of the communication device 100 by means of short message service.

As shown in FIG. 10, in this embodiment, the processing unit 2 includes a control module 21 and a short message service (SMS) module 23. The control module 21 is configured to implement the personalization procedure. The SMS module 23 is configured to process related content of the information element 53 about short message service.

As shown in FIG. 8, the transceiving unit 1 is operable to receive the OTA message 5 from the personalization server 300 through the wireless network 200 in step S10 (similar to step S10 of the first embodiment). Then, in step S20, the processing unit 2 is operable to determine if the OTA message 5 includes the personalization data to be used for personalizing the communication device 100. In this embodiment, step S20 includes the following sub-steps.

In sub-step S23, according to the protocol discriminator 50 of the OTA message 5, the control module 21 is operable to send the information element 53 about SMS to the SMS module 23 for processing the information element 53.

In sub-step S24, the SMS module 23 is operable to determine if the information element 53 includes the personalization message 531. If it is determined that the information element 53 includes the personalization message 531, the control module 21 is operable to implement the personalization procedure of the communication device 100 in step S30 (similar to step S30 of the first embodiment). Therefore, the personalization procedure can be completed without an additional work station or execution of particular software so as to reduce the time for personalization of the communication device 100 and increase the production efficiency.

On the other hand, if the SMS module 23 determines in sub-step S24 that the information element 53 does not include the personalization data (i.e., an ordinary short message is received in step S10), the control module 21 is operable to control the display unit 4 to display the content of the ordinary short message in step S40. It should be noted that, in sub-step S33 of this embodiment (see FIG. 4), the control module 21 is operable to decode the personalization message 531 to thereby obtain the personalization data.

Furthermore, a computer program product (such as a compact disc, a digital versatile disc, etc.) according to this invent ion may include a machine readable storage medium having program instructions stored therein. When the program instructions are executed by an electronic apparatus (for example, a computer), the electronic apparatus is configured to perform the aforementioned steps of the method of OTA personalization of a communication device.

In summary, the method of OTA personalization of a communication device according to this invention allows the communication device 100 to receive the OTA message 5 that includes the personalization data from the personalization server 300 through the wireless network 200. The OTA message 5 may be a short message or an L3 message, and the communication device 100 can execute the personalization data to implement the personalization procedure upon receiving any type of the OTA message 5. Since the personalization procedure can be completed without requirement of an additional work station or execution of particular software, the time for personalization is reduced, and the production efficiency is increased.

While the present invention has been described in connection with what are considered the most practical and embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of over-the-air (OTA) personalization of a communication device, said method comprising the following steps of:
configuring the communication device to receive an OTA message;
configuring the communication device to determine if the OTA message includes personalization data to be used for personalizing the communication device; and
when it is determined that the OTA message includes the personalization data, configuring the communication device to implement a personalization procedure according to the personalization data.

2. The method as claimed in claim 1, wherein:
the OTA message includes an information element for personalization, and a protocol discriminator corresponding to the information element, the information element including the personalization data; and
the communication device is configured to decode the protocol discriminator to thereby determine if the information element includes the personalization data.

3. The method as claimed in claim 1, wherein:
the OTA message includes an information element about mobility management that has a sub-message for personalization and a message type corresponding to the sub-message, the sub-message including the personalization data; and
the communication device is configured to decode the message type to thereby determine if the sub-message includes the personalization data.

4. The method as claimed in claim 1, wherein:
the OTA message includes an information element about short message service that has a personalization message, the personalization message including the personalization data; and
the communication device is configured to determine if the information element about short message service includes the personalization data.

5. The method as claimed in claim 1, further comprising:
configuring the communication device to decode the OTA message to obtain the personalization data;
configuring the communication device to determine if the personalization data is correct; and
when it is determined that the personalization data is correct, configuring the communication device to implement the personalization procedure according to the personalization data.

6. The method as claimed in claim 5, further comprising: after configuring the communication device to determine if the personalization data is correct, the sub step of configuring the communication device to output an error message when it is determined that the personalization data is incorrect.

7. The method as claimed in claim 6, further comprising: prior to configuring the communication device to decode the OTA message to obtain the personalization data, configuring the communication device to determine whether the personalization procedure has been implemented in the communication device, and configuring the communication device to decode the OTA message to obtain the personalization data is implemented when it is determined that the personalization procedure has not yet been implemented.

8. A computer program product comprising a machine readable storage medium having program instructions stored therein which when executed cause a processing unit to perform a method of over-the-air personalization of a communication device according to claim 1.

9. A communication device capable of communication with a personalization server through a wireless network, said communication device comprising:
a transceiving unit for receiving an over-the-air (OTA) message from the personalization server; and a processing unit coupled to said transceiving unit, said processing unit being operable to determine if the OTA message includes personalization data to be used for personalizing the communication device, and to implement a personalization procedure according to the personalization data when it is determined that the OTA message includes the personalization data.

10. The communication device as claimed in claim 9, wherein:
said transceiving unit is able to receive the OTA message that includes an information element for personalization, and a protocol discriminator corresponding to the information element; and
said processing unit is operable to decode the protocol discriminator to thereby determine if the information element includes the personalization data.

11. The communication device as claimed in claim 9, wherein:
said transceiving unit is able to receive the OTA message that includes an information element about mobility management having a sub-message for personalization and a message type corresponding to the sub-message, in which the sub-message can include the personalization data; and
said processing unit includes a control module and a mobility management module, said mobility management module being operable to decode the message type to thereby determine if the sub-message includes the personalization data, said control module being operable to implement the personalization procedure according to the personalization data when said mobility management module determines that the sub-message includes the personalization data.

12. The communication device as claimed in claim 9, wherein:
said transceiving unit is able to receive the OTA message that includes an information element about short message service, in which the information element can have a personalization message that includes the personalization data; and
said processing unit includes a control module and a short message service module, said short message service module being operable to determine if the information element about short message service includes the personalization data, said control module being operable to implement the personalization procedure according to the personalization data when said short message service module determines that the information element includes the personalization data.

13. A method of over-the-air (OTA) personalization of a communication device, said method comprising the following steps of:
configuring the communication device to receive an OTA message that includes personalization data for personalizing the communication device;
configuring the communication device to decode the OTA message to obtain the personalization data;
configuring the communication device to determine if the personalization data is correct; and
when it is determined that the personalization data is correct, configuring the communication device to implement a personalization procedure according to the personalization data.
